(19) United States
(12) Patent Application Publication
(10) Pub. No.: US 2012/0011003 A1
(43) Pub. Date: Jan. 12, 2012

(54) Review of Advertisements

(75) Inventors: Russell K. Ketchum, Newport Beach, CA (US); Jagpreet S. Duggal, Seattle, WA (US)

(73) Assignee: GOOGLE INC., Mountain View, CA (US)

(21) Appl. No.: 12/831,969

(22) Filed: Jul. 7, 2010

(51) Int. Cl. G06Q 30/00

(52) U.S. Cl. 705/14.72

(57) ABSTRACT

Among other things, techniques and systems are disclosed for reviewing ad campaigns prior to presentation by a publisher. Specifically, the techniques and systems enable a publisher to decline advertisement creatives (or individual ads) that the publisher finds objectionable or otherwise does not want to publish. A disclosed method includes receiving, from an advertiser, a plurality of ad campaigns each including a set of creatives and a schedule. The method further includes reviewing an ad campaign from the plurality of ad campaigns to identify an objectionable creative. Furthermore, the method includes identifying one or more instances of the objectionable creative in other ad campaigns from the plurality of ad campaigns based on the review of the ad campaign and before review the other ad campaigns. For each of the other ad campaigns having at least an instance from among the identified one or more instances of the objectionable creative, the method also includes automatically generating a modified schedule and a modified set of creatives including the set of creatives minus the objectionable creative.

### TECHNICAL FIELD

This specification relates to review of advertisements.

### BACKGROUND

Advertisers target advertising to particular groups of consumers by tailoring advertising campaign media, the frequency of the ad campaign, the nature of the advertisements, and based on other variables. For example, advertisers may select publishers that can present advertisements online, broadcast radio and television and/or in printed materials such as newspapers and yellow pages.

Publishers benefit financially from being selected by an advertiser to present an ad campaign, each of which tends to include multiple ads. Once an advertiser chooses a particular publication in which to run its ad campaign, the publisher typically will review the content of the actual ads to ensure that they are unobjectionable to the publisher.

### SUMMARY

Among other things, techniques and systems are disclosed for reviewing advertisements prior to and/or after presentation by a publisher. Specifically, the techniques and systems enable a publisher to decline advertisement creatives that the publisher finds objectionable or otherwise does not want to publish.

In one aspect, a computer-implemented method performed at a hub system for reviewing advertisements is described. The method includes receiving, from an advertiser, a plurality of ad campaigns each including a set of creatives and a schedule. The method further includes reviewing an ad campaign from the plurality of ad campaigns to identify an objectionable creative. Furthermore, the method includes identifying one or more instances of the objectionable creative in other ad campaigns from the plurality of ad campaigns based on the review of the ad campaign and before review the other ad campaigns. For each of the other ad campaigns having at least an instance from among the identified one or more instances of the objectionable creative, the method also includes automatically generating a modified schedule and a modified set of creatives including the set of creatives minus the objectionable creative.

These and other implementations can include one or more of the following features. The method further includes reviewing the other ad campaigns from the plurality of ad campaigns but skipping the objectionable creative. Reviewing the ad campaign includes examining a creative including media and ad campaign specific information, and identifying the examined creative as objectionable based on the media being objectionable relative to policy mandated by at least one of the hub, a publisher, or a government entity. Identifying the examined creative objectionable includes flagging the media including a media file and media specific information. The method can also include providing, to the advertiser, a summary including unique identifiers of the flagged media. In addition, the method can include rejecting the objectionable creative. Further, the method includes instructing the publisher to present the reviewed ad campaigns according to respective modified schedules, and providing, to the advertiser, a report including identifiers of the creatives identified objectionable.

In some implementations, reviewing the ad campaign further includes removing the objectionable creative from the set of creatives, by extracting the objectionable creative from the set of creatives, or by flagging the objectionable creative to disallow presentation of the flagged creative by a publisher. Reviewing the ad campaign also includes revising the schedule of the ad campaign to account for spots vacated by the removed creative. Reviewing the ad campaign further includes examining a default creative selected by the advertiser. If the examined default creative is not objectionable, the schedule of the ad campaign can be revised by filling the spots vacated by the removed creatives with the default creative. If the examined default creative is objectionable, then the ad campaign can be identified as objectionable, or the schedule of the ad campaign can be revised to retain the spots vacated by the removed creatives. Revising the schedule of the ad campaign includes redistributing the set of creatives minus the removed creative to preserve a relative proportion of time, among creatives of the revised schedule, corresponding to the schedule.

In some implementations, the method includes identifying instances of creatives of the reviewed ad campaign in the other ad campaigns from the plurality of ad campaigns before reviewing the other ad campaigns, and reviewing the other ad campaigns from the plurality of ad campaigns but skipping the creatives of the reviewed ad campaign.

According to another aspect, the described subject matter can also be implemented in an internet-based server system for reviewing a plurality of ad campaigns. The internet-based server system includes a computerized electronic device communicatively coupled to a first computer system at a publisher, and a second computer system at an advertiser. The computerized electronic device is configured to receive, from an advertiser, a plurality of ad campaigns each including a set of creatives and a schedule. Further, the computerized electronic device is configured to review an ad campaign from the plurality of ad campaigns to identify an objectionable creative, then to identify one or more instances of the objectionable creative in other ad campaigns from the plurality of ad campaigns based on the review of the ad campaign and before reviewing the other ad campaigns. For each of the other ad campaigns having at least an instance from among the identified one or more instances of the objectionable creative, the computerized electronic device is configured to automatically generate a modified schedule and a modified set of creatives including the set of creatives minus the objectionable creative, and to review the other ad campaigns from the plurality of ad campaigns but skipping the objectionable creative.

These and other implementations can include one or more of the following features. The computerized electronic device is configured to examine a creative including media and ad campaign specific information, and to identify the examined creative as objectionable based on the media being objectionable relative to policy mandated by at least one of the internet-based server system, a publisher, or a government entity. In some implementations, the computerized electronic device is configured to flag the media including a media file and media specific information, and to provide, to the advertiser, a summary including unique identifiers of the flagged media. Further, the computerized electronic device is configured to reject the objectionable creative.

In some implementations, the computerized electronic device is configured to remove the objectionable creative from the set of creatives, and to revise the schedule of the ad campaign to account for spots vacated by the removed creative. For example, the computerized electronic device configured to examine a default creative selected by the advertiser. If the examined default creative is not objectionable, the schedule of the ad campaign can be revised by filling the spots vacated by the removed creatives with the default creative. If the examined default creative is objectionable, then the ad campaign can be identified as objectionable, or the schedule of the ad campaign can be revised to retain the spots vacated by the removed creatives. The set of creatives minus the removed creative can be redistributed to preserve a relative proportion of time, among creatives of the revised schedule, corresponding to the schedule.

In some implementations, the computerized electronic device is configured to identify instances of creative of the reviewed ad campaign in the other ad campaigns from the plurality of ad campaigns before review of the other ad campaigns from the plurality of ad campaigns, and to review the other ad campaigns from the plurality of ad campaigns but skipping the creatives of the reviewed ad campaign. Further, the computerized electronic device is configured to instruct the publisher to present the reviewed ad campaigns according to respective modified schedules, and to provide, to the advertiser, a report including identifiers of the creatives identified objectionable.

According to another aspect, the described subject matter can also be implemented in another internet-based server for reviewing a plurality of ad campaigns. The internet-based server system includes a first input configured to receive, from an advertiser computer system, a plurality of ad campaigns each including respectively a set of creatives and a schedule. Further, the internet-based server system includes a storage device coupled to the first input and configured to host a campaign database including the plurality of ad campaigns. Furthermore, the internet-based server system includes a second input configured to receive, from a publisher computer system, information including policy that defines an objectionable creative. The internet-based server system includes further includes a reviewer unit communicatively coupled to the storage device and to the second input. The reviewer unit is configured to review an ad campaign from the plurality of ad campaigns to identify an objectionable creative, and to identify one or more instances of the objectionable creative in other ad campaigns from the plurality of ad campaigns based on the review of the ad campaign and before reviewing the other ad campaigns. For each of the other ad campaigns having an instance of the objectionable creative, the reviewer unit is further configured to automatically generate a modified schedule and a modified set of creatives including the set of creatives minus the objectionable creative, and to review the other ad campaigns from the plurality of ad campaigns but skipping the objectionable creative.

These and other implementations can include one or more of the following features. The internet-based server system includes a processor communicatively coupled to the storage device and to the reviewer unit. The processor is configured to check the modified schedule of each reviewed ad campaign for available presentation slots at the publisher, and to prepare a report including identifiers of the creatives identified objectionable. The internet-based server system also includes a first output communicatively coupled to the processor configured to provide, to the publisher, the reviewed ad campaigns for presentation according to the modified schedule, and a second output communicatively coupled to the processor configured to provide the report to the advertiser.

According to another aspect, the described subject matter can be implemented as a process performed at a hub system. The process includes receiving, from an advertiser, a plurality of creatives and a plurality of ad campaigns. Each one of the plurality of ad campaigns includes a set of creatives and a schedule. The process further includes reviewing the received plurality of creatives to identify an objectionable creative, and identifying one or more instances of the objectionable creative in the received plurality of ad campaigns. Further, the process includes modifying each ad campaign from the received plurality of ad campaigns having an instance of the objectionable creative. Modifying each ad campaign includes automatically generating a modified schedule, and flagging the objectionable creative to disallow presentation of the flagged creative by a given publisher.

These and other implementations can include one or more of the following features. Modifying of the ad campaigns includes revising the schedule of each modified ad campaign to account for spots vacated by the flagged creative. Revising of the schedule of each modified ad campaigns includes examining a default creative selected by the advertiser. If the examined default creative is not flagged, the schedule of the ad campaign can be revised by filling spots vacated by the flagged creative with the default creative. If the examined default creative is flagged, then the ad campaign can be identified as objectionable, or the schedule of the ad campaign cam be revised to retain the spots vacated by the flagged creative. Revising of the schedule of each modified ad campaigns includes redistributing the set of creatives minus the flagged creative to preserve a relative proportion of time, among creatives of the revised schedule, corresponding to the schedule.

The subject matter described in this document potentially can provide various advantages. For example, if the same objectionable ad may be used in different ad campaigns, the system and techniques described in this specification may enable a reviewer to reject the objectionable ad at creative level. Therefore, the reviewer can avoid having to review and reject multiple times an objectionable ad that appears in multiple ad campaigns. In another aspect, the methods described here may provide a predictable and streamlined experience for advertisers. Once a creative is approved by a given publisher, the approved creative can be reused in future ad campaigns targeting the publisher without undergoing subsequent reviews. Such a review process may enable an advertiser's campaign to get ads on the air quickly.

The subject matter described in this specification can be implemented as a method or as a system or using computer program products, tangibly embodied in information carriers, such as a CD-ROM, a DVD-ROM, a HD-DVD-ROM, a Blue-Ray drive, a computer memory, and a hard disk. Such computer program products may cause a data processing apparatus to conduct one or more operations described in this specification.

In addition, the subject matter described in this specification can also be implemented as a system including a processor and a memory coupled to the processor. The memory may encode one or more programs that cause the processor to perform one or more of the method acts described in this specification. Further the subject matter described in this specification can be implemented using various data processing machines.

Other features, aspects, and potential advantages of the subject matter of this specification will be apparent from the description and drawings, and from the claims.

### DESCRIPTION OF DRAWINGS

FIG. 1(a) is a schematic of an exemplary system for reviewing advertisements prior to presentation by a third party publisher.

FIG. 1(b) is a block diagram of a hub configured to review advertisements prior to presentation by a third party publisher, the hub in communication with an advertiser and the third party publisher.

FIGS. 1(c) is a block diagram of a database hosted at the hub and configured to store advertisement campaigns.

FIG. 2 shows a state diagram of a process for reviewing advertisements prior to presentation by the third party publisher.

FIG. 3 is another block diagram of the database hosted at the hub and configured to store advertisement campaigns and media corresponding to the stored advertisement campaigns, including flagged media.

FIG. 4 illustrates an exemplary interface for reviewing advertisements prior to presentation by the third party publisher.

FIG. 5 shows another state diagram of the process for reviewing advertisements prior to presentation by the third party publisher.

FIG. 6 is the other block diagram of the database hosted at the hub and configured to store advertisement campaigns and media corresponding to the stored advertisement campaigns, including multiple categories of flagged media.

FIG. 7 is a schematic diagram of a computerized electronic device.

### DETAILED DESCRIPTION

Techniques and systems are disclosed for reviewing ad campaigns prior to and/or after presentation by a publisher. Specifically, the techniques and systems enable a publisher to decline advertisement creatives (or individual ads) that the publisher finds objectionable or otherwise does not want to publish.

A central role in the system described in this specification is played by an internet-based provider of advertising services that can select, on behalf of an advertiser, a publisher to present the advertiser's ad campaigns. The internet-based provider of advertising services may review the ad campaigns received from the advertiser for compliance to its own policy. In other implementations, once the ad campaigns are approved against its own policy, the internet-based provider of advertising services can provide to the publisher the approved ad campaigns, such that the publisher may review the provided ad campaigns for compliance to policy self-imposed by the publisher or mandated by a government entity (e.g., a governmental agency such as the Federal Communications Commission (FCC) or the like). A review process based on tracing rejected ads across ad campaigns, for example, from a reviewed ad campaign to ad campaigns remaining for review, enables skipping the previously rejected ads during the review of the remaining ad campaigns. Such a review process implemented by the internet-based provider of advertising services can reduce time and resources for reviewing multiple ad campaigns. Subsequently, the internet-based provider of advertising services may provide the reviewed ads to the selected publisher, and may provide feedback from the ad campaign review process traceable directly to rejected ads to the advertiser.

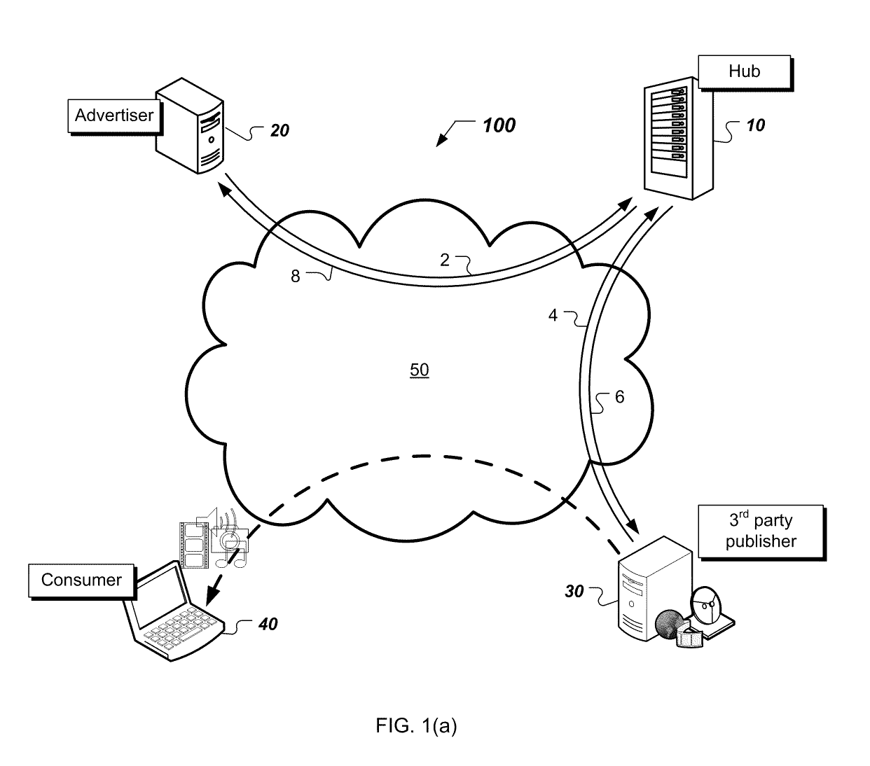

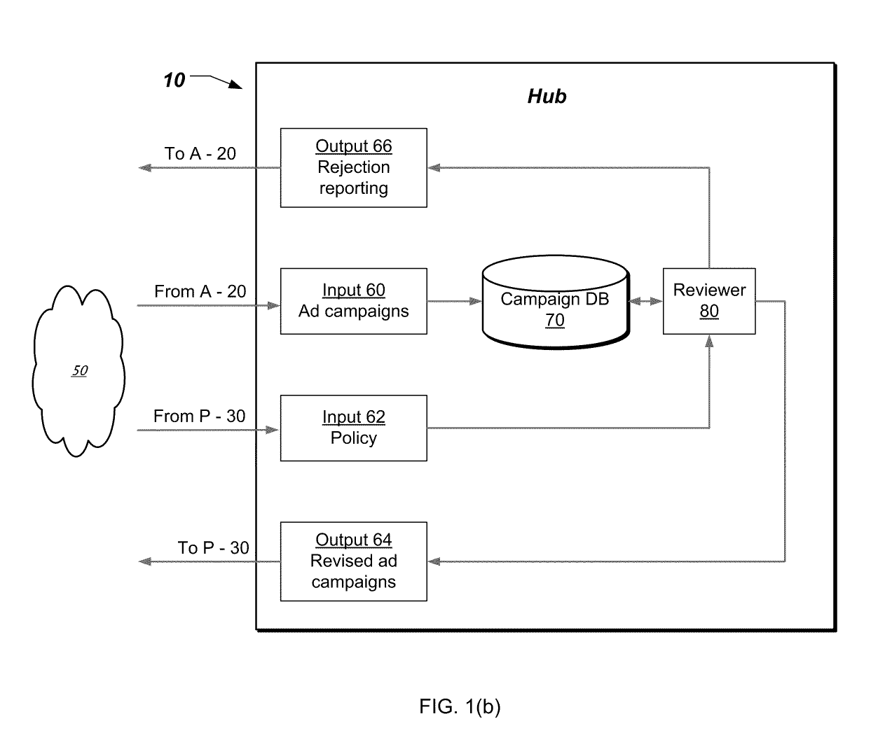

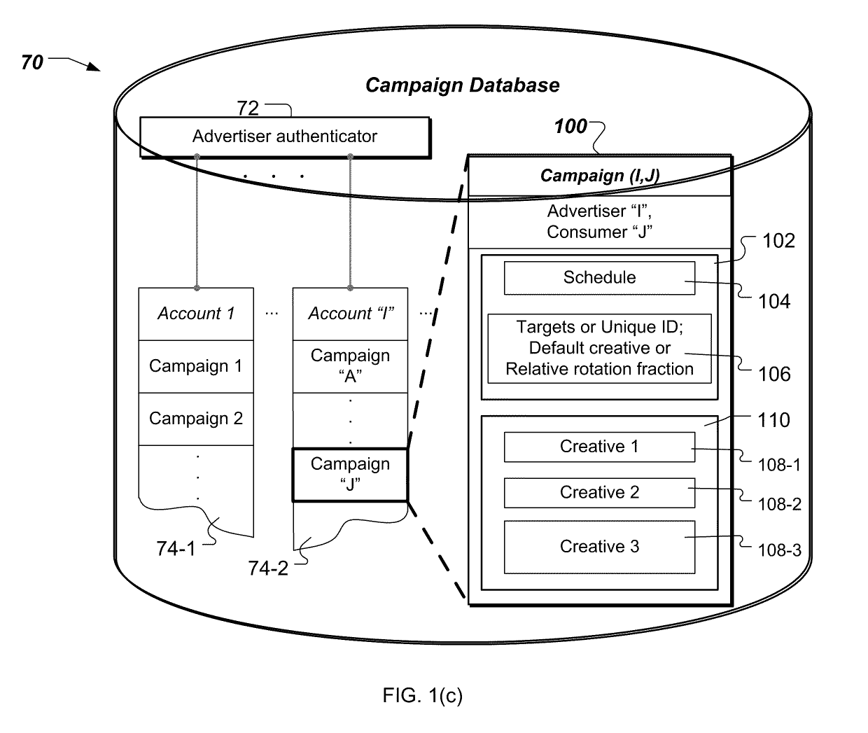

FIG. 1(a) illustrates a schematic of an exemplary system 100 configured to review advertisements prior to presentation by a publisher. System 100 refers to an internet-based provider of advertising services 10 in communication with an advertiser 20 and a publisher 30. Throughout this specification, devices or systems communicate with the internet-based provider of advertising services 10 via data communication networks based on the internet 50. A multitude of information can be exchanged over the internet-based communication links, such as text, pictures, music, video, live TV and multimedia. There may be a temporal aspect associated with the internet-based communication links represented with continuous lines. For example, the time instances denoted by the numerical references 2, 4, 6 and 8 may be represented sequentially.

The internet-based provider of advertising services 10 includes a main server. Throughout this specification, the internet-based provider of advertising services 10 is interchangeably referred to as the main server 10, or the internet-based server 10. Furthermore, because the internet-based provider of advertising services 10 plays a central role in the system disclosed in this specification, the internet-based provider of advertising services 10 is also referred to as the hub 10. The internet-based provider of advertising services 10 can be, for example, Google.

The hub 10 can communicate with a multitude of third party publishers. For example, one such publisher 30 is illustrated in FIG. 1(a). The publisher 30 is interchangeably referred to as a third party publisher 30 to emphasize the fact that the hub 10 does not control the publisher's equipment 30 configured to present ads. Instead, an agreement between the hub 10 and the third party publisher 30 can require that, once the hub 10 provides the ad campaign, including the set of commercials (creatives) and an intended ad schedule, to the selected publisher 30, then it is the publisher's responsibility to present the set of commercials (creatives) according to the intended ad schedule.

Additionally, the publisher 30 includes publishing equipment configured to present publishing content to a publisher's audience 40. The presentation of the publishing content can be carried out via data communication networks based on the internet 50. A multitude of media can be presented over the internet-based communication links (illustrated by dashed-lines), such as text, pictures, music, video, live TV and multimedia.

For example, the publishing content may be radio content, such as music, or sports, and the publisher 30 may be an internet-radio station. Furthermore, presenting the publishing content may include streaming the radio content from the internet-radio station 30 to the publisher's audience 40, in this case consumers of internet-radio content, or internet-radio listeners. In some implementations, presenting the ads by the internet-radio station can be achieved using equipment configured to stream the audio content of the ad accompanied by text and or images. In other implementations, presenting the ads by the internet-radio station 30 can require equipment further configured to stream video content. Furthermore, in one aspect, the ads can be presented in a streaming broadcast manner, i.e., all listeners of the internet-radio station 30 may receive the same ad at a select time. In another aspect, each listener of the internet-radio station may receive personalized ads based on, for example, a listener's profile.

In another example, the publishing content may be live TV content, such as shows or live sports events, and the publisher 30 may be an internet-TV station. Additionally, presenting the publishing content may include streaming live TV content, from the internet-TV station 30, to the publisher's audience 40, in this case consumers of internet-TV content, or internet-TV viewers. In some implementations, presenting the ads by the internet-TV station 30 can be achieved using equipment configured to stream the audio and video content of the ad. Furthermore, in one aspect, the ads can be presented in a streaming broadcast manner, i.e., all viewers of the internet-TV station 30 may receive the same ad at a select time. In another aspect, each viewer of the internet-TV station 30 may receive personalized ads based on, for example, a viewer's profile.

The foregoing examples refer to online streaming of audio and video content. In other implementations, publishing content may include movie previews presented before the beginning of a motion picture, and the publisher 30 may be a motion picture theatre. Additionally, presentation of the publishing content may include projecting the movie previews, using equipment operated at the movie theatre 30, to movie theatre goers 40. Presenting the ads at the movie theatre 30 can be achieved using equipment further configured to project audio and video content of the ad. Furthermore, the ads can be presented in a broadcast manner, i.e., all viewers present in the room see the same ads during the movie previews.

In yet other implementations, the publishing content may be radio content, such as music, or sports, and the publisher 30 may be an over-the-air radio station. Additionally, presentation of the publishing content may include broadcasting the radio content from terrestrial-based or satellite-based radio station 30 to the publisher's audience 40, in this case consumers of radio content, or radio listeners. In some implementations, presenting the ads by the internet-radio station can be achieved using equipment configured to broadcast audio content of the ad as described in literature. [dMarc/Google patent applications and/or issued patents.] Furthermore, the ads can be presented in a broadcast manner, i.e., all listeners of the over-the-air radio station may receive the same ad at a select time.

Based on the foregoing examples, ads can be presented by a publisher via internet streaming or over-the-air transmissions, in a broadcast manner (the same ad is presented simultaneously to many consumers) or in a personalized manner (different ads are sent to each consumer according to a consumer's preferences). Furthermore, the presented ads can cover a variety of media, e.g., text, pictures, music, video, live TV, or combinations of media (multimedia).

Referring again to FIG. 1(a), at time 2, the hub 10 can communicate via the internet 50 with the advertiser 20. In some implementations, the advertiser 20 includes a computer system, such as a desktop PC, laptop or any other computerized electronic device used by the advertiser 20 to create and store ad campaigns. In other implementations, the advertiser 20 can access a web based application to create an ad campaign. The ad campaign can be stored on the internet-based server 10. As discussed in more detail later, the ad campaign includes a set of ads (commercials or creatives) and ad campaign information. The ad campaign information contains, for example, ad campaign targets such as demographics, markets, individual broadcasting stations, channels, etc., a rotation schedule for the set of ads, a default ad, and more. As part of the communication at time 2, the hub 10 can receive the ad campaigns from the advertiser 20 when the advertiser 10 uploads the ad campaigns to the main server 10. In other implementations, the hub 10 can pull (download) the ad campaigns from the advertiser system 20, based on a predetermined agreement.

Referring now to FIG. 1(b), the hub 10 includes an input 60 to receive the ad campaigns from the advertiser 20. The input 60 may include a graphical user interface where the advertiser 20 may authenticate prior to accessing an account, after which the advertiser 20 may enter ad campaign information and may upload commercials (creatives) included in the ad campaign.

A storage device 70 is communicatively coupled to the input 60. The storage device 80 hosts a campaign database. Throughout this specification, the numerical reference used interchangeably for the storage device and for the campaign database is 70. The ad campaigns received by the hub 10, from the advertiser 20, through the input 60, are being relayed to the storage device 70 and stored in the campaign database 70.

The data structure of the campaign database 70 is illustrated diagrammatically in FIG. 1(c). In some implementations, a relational database 70 may include tables 74 (e.g., 74-1, 74-2, . . . ), each table corresponding to an account (or advertiser). The records in each table 74 contain the ad campaigns of each respective advertiser. For example, the ad campaign 100 labeled “I, J”, corresponds to ad campaign “J” of advertiser “I”. In another example, the name “I, J” of the ad campaign 100 can indicate the names (or ids) of an advertiser named “I” and a consumer named “J” respectively. A request for access to specific ad campaigns is handled by an authentication module 72. Therefore, an advertiser 20 can have access only to the advertiser's campaigns stored, for example in table 74-1, and not to another advertiser's campaigns stored, for example in table 74-2, in the campaign database 70 at the hub 10.

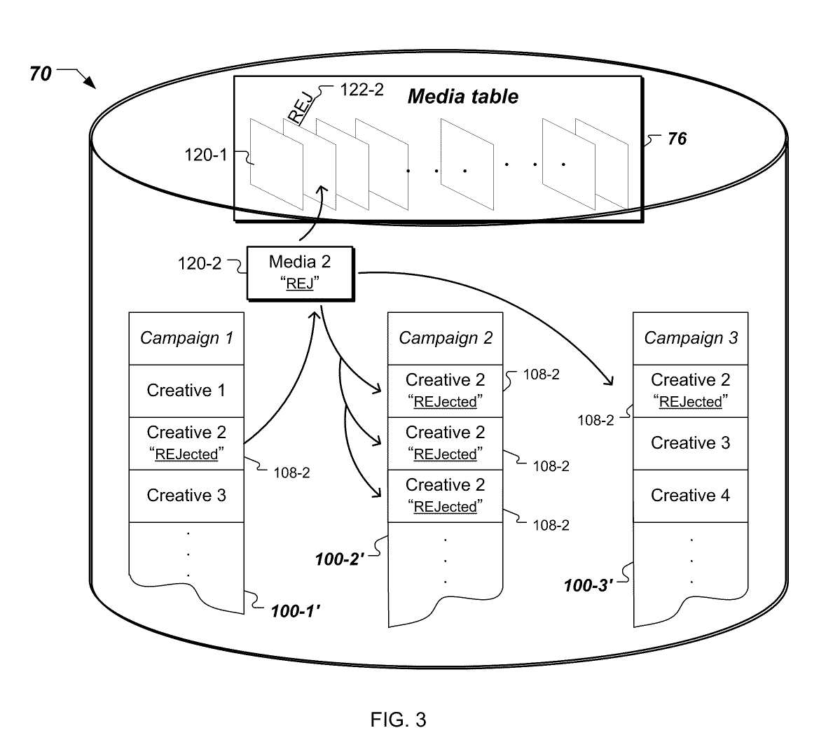

Each ad campaign 100 labeled, e.g., “I, J”, contains two types of records: ad campaign information 102 and a set of creatives 108. The ad campaign information includes an intended ad schedule 104, and additional campaign information 406. The additional campaign information 106 may include one or a combination of campaign targets, a consumer's unique identifier, a consumer's profile, etc. The set of creatives 108 includes a number of creatives 108-1, 108-2, 108-3, . . . A creative includes campaign specific data and a piece of media. For example, the campaign specific data may include a default/non-default designation of the creative, an intended presentation time, etc. The (piece of) media, which is actually presented by a publisher 30, and the role the media plays in the review process disclosed in this specification are being discussed in detail with respect to FIG. 3.

Returning to FIG. 1(a), the hub 10 receives the ad campaigns from the advertiser 20, parses the ad campaign information and schedules the ad campaigns for presentation with best suited publishers 40. The best suited characteristic of a publisher may include a presentation time slot (day time, day of the week), a demographic and/or a geography of the publisher's audience, and other criteria. The ad schedule can be agreed upon between the hub and a publisher based on either a reservation process or a bidding process. Furthermore, a publisher 30 may control and/or own one publishing station 30 or a group of publishing stations. Thus, the hub 10 may have agreements at owner-group level (applicable to multiple publishing stations owned by the owner-group), or agreements at publishing station level (applicable to one independent publishing station, or one of the publishing stations owned by the owner-group).

The hub 10, which is neutral (impartial) with respect to the ad content the publisher 30 chooses to present, can offer the publisher 30 a process for reviewing the content of the ad campaigns designated (via reservation or bidding, as discussed above) prior to presentation by the publisher 30. At time 4, the publisher 30 may remotely log into the hub 10 to review the content of the ad campaigns of advertiser 20 stored at the hub 10.

Referring again to FIG. 1(b), the hub 10 includes another input 62 where, in some implementations, the publisher 30 can enter, for example in a graphical user interface, information regarding the review of ad campaigns. For example, the information regarding the review of ad campaigns can include a policy (set of standards) mandated by a government entity. The policy may establish a basis for rejecting or accepting an ad. The policy may alternatively or additionally be self-imposed by the publisher 30.

In some implementations, a reviewer unit 80, communicatively coupled to the input 62 and the storage device 70, may perform the review of the ad campaigns, (i) at advertiser level, (ii) at ad campaign level or (iii) at creative level, according to rules described later in this specification. In other implementations, the reviewer unit 80 reviews a copy (or a version) of an ad. In such implementations, (a master of) an ad can be a high definition video file that may be several gigabytes large. The reviewer unit 80 may access a version of the ad video optimized for streaming in a web based tool. When the streamed version of the ad is approved, (the master of) the ad may be marked as approved.

The hub 10 also includes an output 64 communicatively coupled to the reviewer unit 80. The output 64 is configured to transmit the reviewed ad campaign to the publisher 30. The reviewed ad campaign provided to the publisher 30 includes the set of reviewed creatives to be presented by the publisher 30 according to a revised ad schedule.

The hub 10 may also include another output 66 communicatively coupled to the reviewer unit 80. Output 66 is configured to transmit feedback to the advertiser 20. When the ad rejection is performed (i) at advertiser level, then the feedback transmitted to the advertiser may include a notification that the advertiser's ad campaigns have been rejected or accepted. When the ad rejection is performed (ii) at ad campaign level, then the feedback transmitted to the advertiser may include unique identifiers of the rejected ad campaigns. When the ad rejection is performed (iii) at creative level, then the feedback transmitted to the advertiser may include unique identifiers of the rejected creatives.

Referring once again to FIG. 1(a), at time 6, the hub 10 transmits the reviewed ad campaign to the publisher 30 (as described above). And, at time 8, the hub 10 transmits feedback to the advertiser 20 (as described above).

The process implemented at hub 10 for reviewing ad campaigns prior to presentation by a publisher can be based on the rules described below.

In some implementations, ads can be rejected at advertiser level. For example, a publisher can reject all ads of advertiser X. If a rejection is placed via input 62 at advertiser level, then all ads from advertiser X are being rejected. That means that none of the ad campaigns that belong to advertiser X can be presented on the publisher's station (e.g., on the publisher's radio station). Additionally or alternatively, rejections at advertiser level can apply to all stations. For example, none of the ad campaigns that belong to advertiser X can be presented on any of the publisher's stations.

In other implementations, a publisher 30 can log on to input 62 of the hub 10 and authenticate at owner-group level, to make decisions regarding all the publishing stations within the group. A user authenticated at the owner-group level, can enter advertiser-level rejections, meaning the user at owner-group level can reject any ad campaign from advertiser X. This user can reject on behalf of all publishing stations in the group, or for individual publishing stations. For example, the user can single out at owner-group level publishing stations for which ad campaigns from advertiser X are rejected. In some implementations, the publisher can reject ads by publishing station format: for example, the publisher can block commercials of advertiser X from being presented on publishing stations that present programs targeted to children or religious programs. The foregoing describes rejection at advertiser level.

In some implementations, ads can be rejected at ad campaign level. For example, an ad campaign can be rejected for the entire group of stations, for selected groupings of stations, for individual stations, or by publishing station format. While being logged-in at input 62 of the hub 10, the publisher 30 can choose to allow presentation of the ad campaign at some publishing stations, and to not allow presentation of the ad campaign at other publishing stations. Rejection of ads at campaign level may not enable a publisher to reject selected creatives of the ad campaign, even if the publisher may want to reject only selected creatives within the ad campaign. For example, a publisher starts the review of an ad campaign that may include multiple creatives. For example, there may be three pieces of audio, or three creatives. The reviewer can listen to the three pieces of audio to make one decision applicable to the entire ad campaign. Thus, the publisher may accept the ad campaign, and all three creatives included in the ad campaign, or the publisher may reject the ad campaign. Therefore, even if there may be only one objectionable creative (that is offensive relative to the previously mentioned policy), while the other two creatives may be fine (relative the foregoing policy), the publisher's only choice is to reject all three creatives. The campaign-level review and rejection process is thus inefficient because the publisher cannot reject only the objectionable (offensive) creative.

In another example, an advertiser 20 has multiple products, and a publisher 30 approves of some of advertiser's products, but does not approve of one specific product (based on to the foregoing policy). In such a case, an advertiser-level rejection may be undesired, because publisher 30 may approve of some of the products of advertiser 20. However, advertiser 20 may book multiple ad campaigns with the hub 10 that include the product that publisher 30 does not approve of For example, the same creative may be used in different ad campaigns, so the creative (and its media) corresponding to the offensive product may be the same across ad campaigns, but the targeting criteria may be different. For these reasons, the publisher may have to review each ad campaign separately, and if the unwanted creative appears in all ad campaigns, the publisher has to separately reject each ad campaign where that creative appears. Therefore, the rejection process can become inefficient because, for example, if only one offensive creative is scheduled in one hundred ad campaigns, then the publisher has to perform 100 separate reviews.

A process for rejecting ad campaigns at creative level enables a publisher that may object to the content of only one offensive creative, which may be scheduled, for example, in one hundred ad campaigns, to decline the offensive creative by taking only one action. Subsequently, any time that creative is used in future ad campaigns, the original rejection stays with the creative and the publisher does not have to review the creative again. Accordingly, the creative-level rejection procedure provides efficient workflow to the benefit of the publisher.

Furthermore, the creative-level rejection procedure is advantageous to the advertiser as well. For instance, the advertiser can benefit from decreased turnaround time to get their ads on the air. Also, an advertiser may experience that a publisher in a select city/market rejects the advertiser's ad campaigns, without providing a reason for the rejection. Such rejections at advertiser or ad campaign level, as described in previous sections of the specification, provide only indirect feedback to the advertiser. For example, when an ad campaign is rejected by a publisher, the advertiser can only infer the reason for the rejection, and may or may not be able to trace the reason back to a specific creative that may have been objectionable to the publisher. If alternatively, the rejection were performed at creative level, the advertiser can receive feedback that is traceable to the rejected creative. The method disclosed in this specification provides direct feedback to the advertiser, because the publisher makes the rejection at creative level, and not at advertiser or ad campaign level. Furthermore, the feedback provided by the hub 10 to the advertiser 20 may identify (e.g., by name) the rejected creatives.

The creative-level rejection of ad campaigns is based on rules. In some examples, an ad campaign may have one creative. If the creative is rejected by the publisher 30 during the ad campaign review, then the ad campaign is rejected. In such situations, the ad campaign cannot play on the publisher's stations. Based on the publisher's criteria the hub 10 determines which of the publisher's stations may be eligible to participate in an auction, and which creatives may be presented on select stations. The hub 10 can determine that the ad campaign has only one creative, and that the publisher has previously rejected the creative from presentation on a group of stations controlled by the publisher. Under the foregoing circumstances, the group of stations controlled by the publisher cannot be considered to present the ad.

In other examples, an ad campaign may have three creatives. One of the three creatives is rejected by a publisher. In some implementations, the ad campaign may specify that the creatives be rotated evenly, i.e., the presentation fraction of the three creatives is 33%, 33%, 33%. Based on the ad campaign specification, if one creative is rejected, the presentation share of the two accepted creatives is 50%, 50%. Therefore, a selection entered prior to the review by the advertiser related to even presentation time among creatives can result in even distribution over the accepted (or non-rejected) creatives.

In other implementations, a default creative is specified to replace a rejected creative. For example, in an ad campaign that has three creatives, the advertiser specifies which of the three creatives is the default creative. In this example, the publisher presents the default creative in place of any rejected creative of the ad campaign. For example, a national store prepares different creatives for presentation in every state. Thus, in this ad campaign, the national store may have 50 creatives, one per state. Examples of creatives may be “Come to my store in New York”, “Come to my store in California”, and so on. The default creative can be “Come to my store near you”, and the default creative can be used anywhere, in any context. Then, if the publisher rejects the New York creative, the revised schedule of the revised ad campaigns specifies that a publisher present the default creative for the rejected ad campaign.

In some instances, the default creative may be rejected by a publisher during the review process. In some implementations, if the default creative is rejected, then the entire ad campaign is rejected. In other implementations, if the default creative is rejected, then no creative is played in the spot of the rejected creative. For example, if the default creative is rejected in New York, rather than playing the default creative “Come to my store near you”, no creative is played in New York for the rest of the ad campaign.

In yet other implementations, the default creative may be interpreted or inferred by the hub 10 based on, for example, information related to the advertiser's campaign goals. For example, the hub 10 may designate a default creative from among the set of accepted creatives, if the advertiser does not indicate, as part of the ad campaign information, a default creative. The foregoing action may be performed by the hub 10 if the ad campaign information lacks a designated procedure for replacing a rejected default creative.

In yet another example, the hub 10 may select another creative from the set of accepted creatives to fill the spot of a rejected creative. For example, the hub 10 can revise the ad schedule to replace a rejected creative with the previously presented creative (or the creative presented before the previously presented creative). In another example, the hub 10 may select no creative in place of a rejected creative. All such revisions performed by the hub 10 can be based on the targeting parameters of the ad campaign or on the method the advertiser chooses to weigh the creatives within the ad campaign.

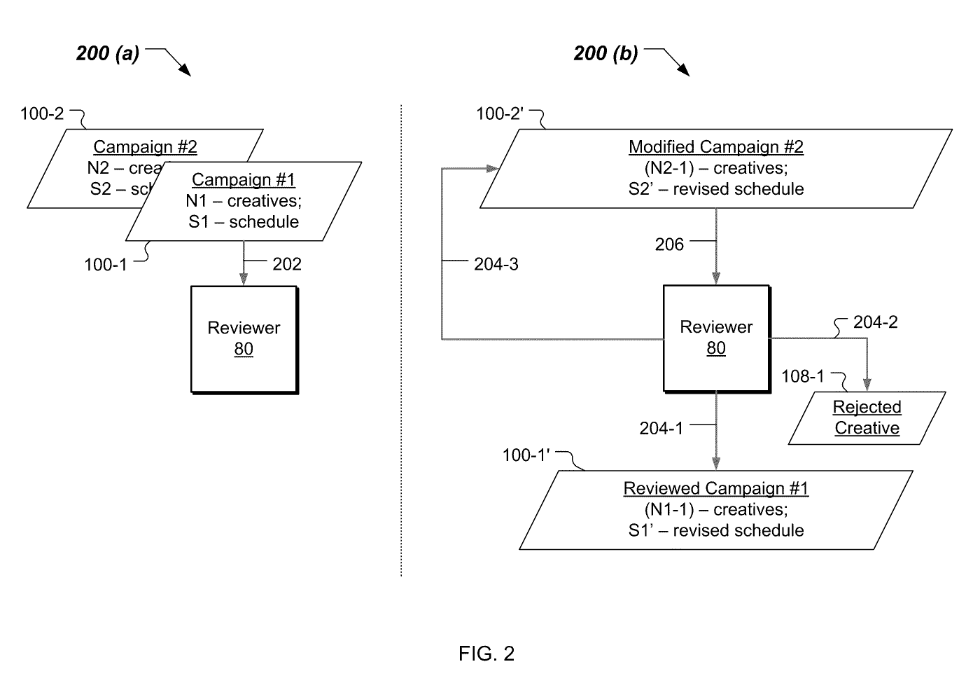

At least some of the rules described above are applied by the hub 10 at the reviewer unit 80 depicted in FIG. 1(b). Referring next to FIG. 2, diagram 200(a) illustrates a state of the hub 10 prior to the review of an advertiser's ad campaigns. Additionally, diagram 200(b) illustrates another state of the hub 10 after the review of one of advertiser's ad campaigns.

The portion of the hub 10 shown in state diagram 200(a) of FIG. 2 is the reviewer unit 80 and the received ad campaigns 100-1 and 100-2. At state 200(a), the first ad campaign 100-1 is being received 202 by the reviewer unit 80 for review based on the rules discussed above in regard to creative-level rejection. In the same state 200(a), the second ad campaign 100-2 is queued for review after the first ad campaign 100-1. The received ad campaign #1 100-1 includes a set of N1 creatives and an ad schedule S1. In some implementations, the number of creatives N1 included in ad campaign #1 100-1 may be N1 larger than 1. In other implementations, there may be one creative (N1=1) included in ad campaign #1 100-1, but that one creative may be scheduled for more than one presentation, according to the ad schedule S2. The received ad campaign #2 100-2 includes a set of N2 creatives and an ad schedule S2.

The portion of the hub 10 shown in state diagram 200(b) of FIG. 2 is the reviewer unit 80, the reviewed first ad campaign 100-1′ and the second ad campaign 100-2′ modified based on the review of the first ad campaign 100-1. At state 200(b), the revised ad campaign 100-1′ is being released 204-1 by the reviewer unit 80 after having been reviewed based on the rules discussed above in regard to creative-level rejection.

Additionally, in the same state 200(b), a rejected creative 108-1 is also being released 204-2 by the reviewer unit 80. The rejected creative 108-1 is identified by the reviewer unit 80, based on the rules discussed above in regard to creative-level rejection, and removed from the revised ad campaign 100-1′. In some implementations, the rejected creative 108-1 may be extracted from the revised ad campaign 100-1′. In other implementations, the rejected creative 108-1 may be retained in the ad campaign 100-1′, but the rejected creative 108-1 can be flagged to disallow presentation of the flagged creative 108-1 by a given (targeted) publisher.

The reviewed ad campaign 100-1′ includes a revised schedule S1′ and a set of (N1-1) reviewed creatives. The set of (N1-1) reviewed creatives that are part of the reviewed ad campaign 100-1′ excludes the rejected creative 108-1.

The revised schedule S1′ is generated by the reviewer unit 80 to account for spots in the schedule S1 vacated by the removed creative 108-1. In some implementations, the received ad campaign 101-1 may have a default creative specified by the advertiser. If the default creative is not rejected by the reviewer unit 80, then the revised schedule S1′ may be generated by placing the default creative into all spots vacated by the rejected creative 108-1. In some cases, if the default creative is rejected by the reviewer unit 80, then the revised schedule S1′ may be generated by retaining the spots vacated by the rejected creative 108-1. In other cases, if the default creative is rejected by the reviewer unit 80, then the entire revised ad campaign 100-1′ may be rejected. In other implementations, the revised schedule S1′ may be generated by redistributing the set of creatives minus the rejected creative 108-1 to preserve the relative distribution of presentation time per creative specified in the original schedule S1.

Further, in the same state 200(b), one or more instances of the rejected creatives are being identified in the remaining second ad campaign #2. The identification of the one or more other instances of the rejected creatives occurs automatically as described in detail below in regard to FIG. 3. Returning to FIG. 2, the remaining second ad campaign #2 is being automatically modified 204-3 to generate a modified ad campaign 100-2′ based on the review of the first ad campaign #1 performed by reviewer unit 80 and before review of the second ad campaign #2. The modified ad campaign 100-2′ includes a modified schedule S2′ and a modified set of (N2-1) creatives. The set of (N2-1) creatives that are part of the modified ad campaign 100-2′ excludes the rejected creative 108-1. The modified schedule S2′ may be generated as described above in regard to generating the revised schedule S1′.

Furthermore, in the same state 200(b), the modified ad campaign 100-2′ is being received 206 by the reviewer unit 80 for review based on the rules discussed above in regard to creative-level rejection. The received modified ad campaign 100-2′ does not include the rejected creative 108-1, as discussed above in regard to modifying 204-3 the second ad campaign #2. Therefore, when reviewing remaining ad campaigns, the reviewer module 80 can skip the previously rejected creative(s). Thus, the process described in FIG. 2 enables the hub 10 to save computing resources by not having to repeatedly review previously rejected creatives.

The notion of media can be introduced to explain how the remaining ad campaigns are automatically modified 204-3, to obtain modified ad campaigns 100-2′, prior to being input 206 for review at the reviewer unit 80. Alongside the notions (discussed above) of advertiser, ad campaign and creative, the notion of media relates to presentation of advertisements. The notion of media may be directly related to the engineering system and may be only indirectly related to the perception of an advertiser or a publisher. The difference between media and creative is that the media (or a piece media) can be a piece of audio or video, while a creative is the media in the context of an ad campaign. The method described in this specification in terms of creative rejection can also be described in terms of media rejection.

The process of creative-level rejection described earlier can also be described in term of media rejection. The previously described New York ad may correspond to a creative if considered from the perspective of an ad campaign. The same sample New York ad may be a piece of media if listened to, for example, on an MP3 player, outside the context of an ad campaign.

FIG. 3 illustrates that a creative and media represent two different database entities. For example, the relational database 70, hosted by the hub 10, stores ad campaigns 100-1, 100-2, . . . Each ad campaign includes a set of creatives 108-1, 108-2, . . . As discussed earlier, each creative includes ad campaign specific data and a respective piece of media. The relational database 70 also includes at least a table 76 that contains media 120-1, 120-2, . . . A piece of media 120-2 may be associated to Creative “2”, while Creative “2” may be contained (and scheduled) in ad Campaign “1” 100-1, ad Campaign “2”, ad Campaign “3”, etc.

Media as a database object can includes an actual digital recording (e.g., audio file, a video file), and additional media specific information (e.g., a name that is shown on the screen, a picture of a poster or album cover, the ID in the database, . . . ) Media is not specific to audio, instead media is any type of creative asset used for advertising that is reviewed at the hub 10.

However, as soon as the media is associated with an ad campaign, the media becomes a creative. Therefore, for example, media can be associated with different creatives when this media belongs to two different ad campaigns. In another example, in the context of an online music site, songs may be considered to be media. However, if a playlist is being built based on music from the online music site, the songs placed into the playlist may be considered creatives, as these songs are now part of a playlist. Even though the same songs are being considered in either context, from the perspective of the database 70, there exists a difference between media and creatives.

The rules that govern ad review introduced earlier, for example, the rules describing creative-level rejections may be based on media rejection. For example, if a piece of media is rejected, a note (also referred to as a flag) is recorded in the database corresponding to the rejected media. In FIG. 3, the flag 122-2 corresponding to rejected media 120-2 may simply say “REJ”. In other implementations, the note 122-2 may include entries indicating that the rejected media 120-2 cannot be presented in X, Y, Z places (markets) or by X, Y, Z stations.

In other implementations, an ad campaign 100-1′ may contain a rejected creative (Creative 2) 108-2. In that case, the rejection corresponding to the rejected creative 108-2 also corresponds to its media 120-2. Thus, the rejection transfers from the rejected creative 108-2 to the corresponding media 120-2.

The implementation illustrated in FIG. 3 corresponds to state 200(b) in FIG. 2, i.e., ad Campaign “1” 100-1 may correspond to a reviewed ad campaign. The reviewer unit 80 may have rejected Creative “2” 108-2, for example because the corresponding media 120-2 may be found to be objectionable. As described above, the rejection of Creative “2” 108-2 may be automatically applied to its media 120-2, thus media 120-2 can be flagged as rejected, for example using the flag “REF 122-2. The outcome of the review process can be the revised ad campaign 100-1′ including the set of revised creatives (excluding Creative “2”) and a revised schedule S1′. For example, the reviewer unit 80 may revise the schedule S1′ to fill the spot of rejected Creative “2” with a default creative or may leave the spot of rejected Creative “2” unfilled.

In some implementations, the name of the rejected Creative “2” 108-2 is identified in the remaining ad campaigns 100-2′ and 100-3′. In other implementations, the flag 122-2 carried by the rejected media 120-2 is applied to the remaining ad campaigns 100-2′ and 100-3′. In either case, the rejection of Creative “2” 108-2 propagates automatically from a previously reviewed ad campaign to ad campaigns to be reviewed subsequently.

Thus, ad campaign 100-2 may initially contain only Creative “2”, scheduled at various times and/or stations. As the rejection of Creative “2” propagates to all remaining ad campaigns, the modified ad Campaign “2” 100-2′ may be rejected de facto because the modified ad Campaign “2” 100-2′ contains only rejected creatives. Additionally, ad campaign 100-3 may initially contain Creative “2”, scheduled during the first presentation slot, followed by Creatives “3”, “4”, . . . As the rejection of Creative “2” propagates to all remaining ad campaigns, the modified ad Campaign “3” 100-3′ may include the set of remaining creatives (excluding Creative “2”) and a revised schedule S3′. For example, the reviewer unit 80 may modify schedule S3′ to fill the spot of Creative “2” with a default creative or may leave the spot of Creative “2” unfilled.

As described above, the review of (the remaining) ad campaigns can be greatly simplified based on previously reviewed ad campaigns. One can appreciate that the efficiency (speed and reduction of computing resources) of the review process may continue to improve as more rejected creatives are being identified, as the identified rejected creatives can be eliminated from the remaining (modified) ad campaigns. Thus the ad campaigns to be reviewed may become sparser and sparser as the number of previously reviewed ad campaigns increases.

In some implementations, the process for reviewing ad campaigns is fully automated and performed by the reviewer unit 80 of the hub 10. Thus, the role played by publisher 30 may be to input (i) the review rules discussed above (defining advertiser, ad campaign or creative-level rejections) and (ii) the rules (policy) that define objectionable ads. In other implementations, the publisher 30 may be more involved in the actual review as described below.

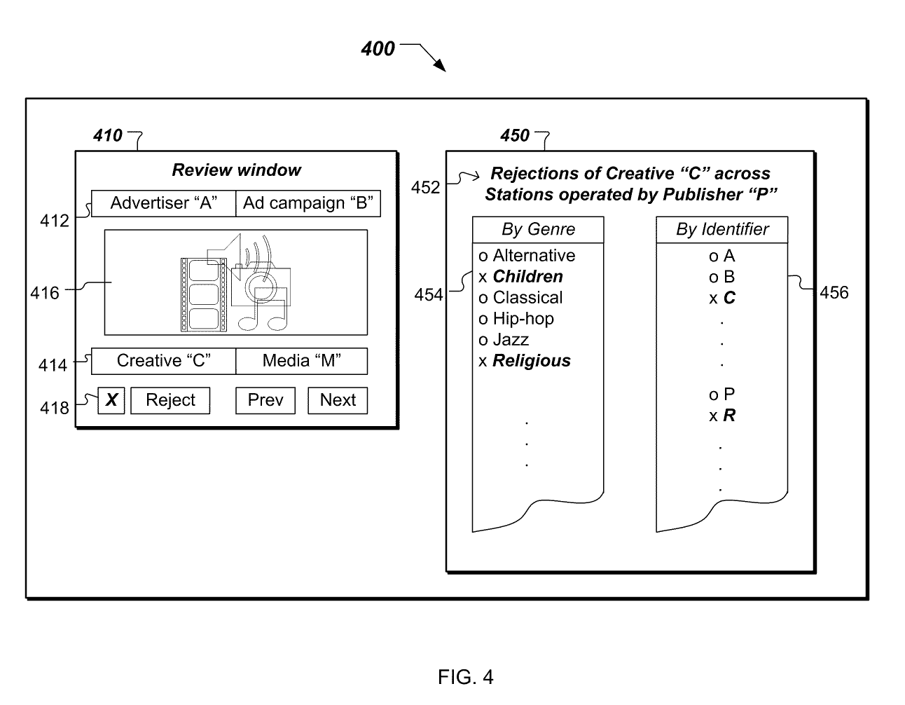

FIG. 4 illustrates a sample graphical user interface (GUI) 400 presented at the hub 10 where a publisher 30 can review ad campaigns prior to presentation of the ad campaigns by the publisher 30. The GUI 400 includes a review window 410 and an additional window 450.

Controls 412 in the review window 410 display unique identifiers corresponding to an advertiser and ad campaign. Controls 414 in the review window 410 display unique identifiers corresponding to a creative, and media corresponding to a creative. The area 416 may correspond to a player for presentation of an ad identified by controls 412 and 414. The controls 418 correspond to rejection of the advertiser, ad campaign or creative identified by controls 412 and 414, and/or presented in area 416.

The entries available in the additional window 450 complement or further constrain the input entered in window 410. For example, FIG. 4 displays in label 452 “Rejections of Creative “C” across stations operated by publisher P”, where the publisher P performs the current review. Once the Creative “C” has been rejected in the review window 410, the reviewer may apply the rejection to select station genres 454, and/or to select stations 456. Thus, the rejected creative cannot be presented at stations publishing children and religious content, and/or cannot be presented at stations C and R. Note that the rejections (and overall review) may refer to streaming or over-the-air broadcast stations. The controls in windows 410 and 450 can be used for creative-level rejections.

In some implementations only controls 412 are enabled, while controls 414 and area 416 are disabled. Thus, advertiser-level rejections or ad campaign-level rejections may be carried out in these implementations. The entries available in the additional window 450 complement the input entered in window 410 when rejecting at advertiser level or ad campaign level in a manner similar to the creative-level rejections described above.

Furthermore, if the publisher 30 accesses the hub 10 at owner-group level, then the publisher 30 may have access to the review window 410 and the additional window 450. If the publisher 30 controls one publishing station, or the review refers to one publishing station, then only the review window may be available.

Even though the publisher plays an active role during the review process, the automated rejection process described above in regard to FIGS. 2 and 3 continues to apply. Thus, returning to FIG. 4, once the reviewer selects a rejected creative at control 418, the rejection propagates to all other instances of the rejected creative for the ad campaign under review and for the remaining ad campaigns. Furthermore, all attributes related to the rejection (i.e., limitations to select radio stations or select genre) propagate with the rejection. Therefore, the reviewer may not be presented again a rejected creative for review.

The process for reviewing ad campaigns featuring creative-level rejections, disclosed above with respect to FIGS. 2 and 3, may be implemented such that the reviewer module 80 can skip creatives that have been rejected as part of previously reviewed ad campaigns. In other implementations the review process described above can be modified to enable the reviewer module 80 to skip creatives that have been either rejected or accepted as part of previously reviewed ad campaigns.

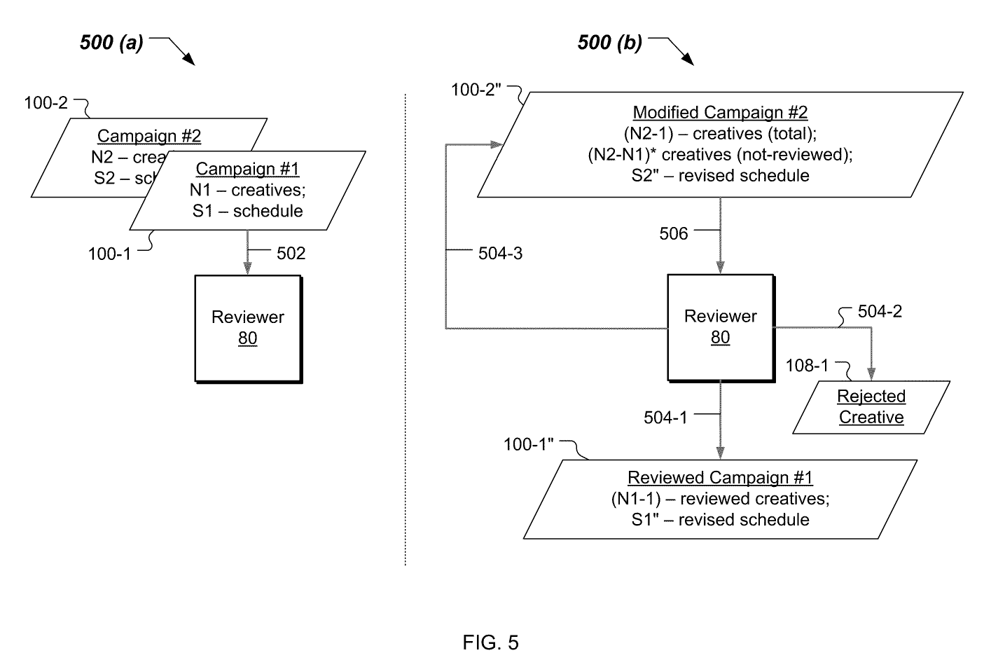

FIG. 5 illustrates an implementation of the modified process for reviewing ad campaigns featuring creative-level rejections. Diagram 500(a) illustrates a state of the hub 10 prior to the review of an advertiser's ad campaigns. Additionally, diagram 500(b) illustrates another state of the hub 10 after the review of one of advertiser's ad campaigns.

The portion of hub 10 shown in state diagram 500(a) of FIG. 5 is the reviewer unit 80 and the received ad campaigns 100-1 and 100-2. At state 500(a), the first ad campaign 100-1 is being received 502 by the reviewer unit 80 for review based on the rules discussed above in regard to creative-level rejection. In the same state 500(a), the second ad campaign 100-2 is queued for review after the first ad campaign 100-1. The received ad campaign #1 100-1 includes a set of N1 creatives and an ad schedule S1. The received ad campaign #2 100-2 includes a set of N2 creatives and an ad schedule S2.

The portion of the hub 10 shown in state diagram 500(b) of FIG. 5 is the reviewer unit 80, the reviewed first ad campaign 100-1″ and the second ad campaign 100-2″ modified based on the review of the first ad campaign 100-1. At state 500(b), the revised ad campaign 100-1″ is being released 504-1 by the reviewer unit 80 after having been reviewed based on the rules discussed above regarding to creative-level rejection.

Additionally, in the same state 500(b), a rejected creative 108-1 is also being released 504-2 by the reviewer unit 80. The rejected creative 108-1 is identified by the reviewer unit 80, based on the rules discussed above in regard to creative-level rejection, and removed from the revised ad campaign 100-1″. In some implementations, the rejected creative 108-1 may be extracted from the revised ad campaign 100-1″. In other implementations, the rejected creative 108-1 may be retained in the revised ad campaign 100-1″, but the rejected creative 108-1 can be flagged to disallow presentation of the flagged creative 108-1 by a given (targeted) publisher.

The reviewed ad campaign 100-1″ includes a revised schedule S1″ and a set of (N1-1) reviewed creatives that have been accepted. The set of (N1-1) accepted creatives that are part of the reviewed ad campaign 100-1″ excludes the rejected creative 108-1.

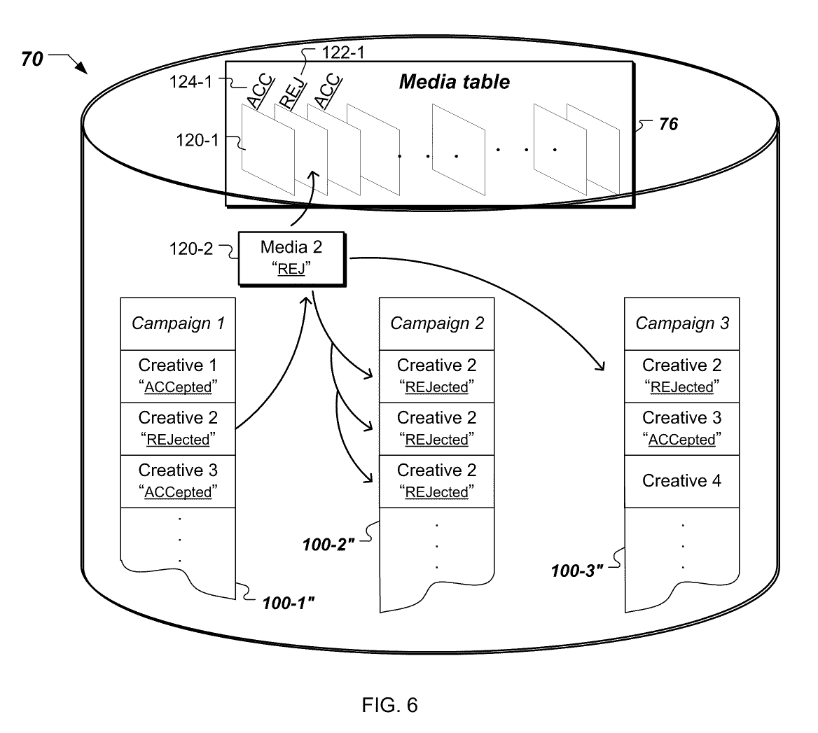

Furthermore, in the same state 500(b), one or more instances of the rejected creatives may be identified in the remaining second ad campaign #2. Additionally, one or more instances of the accepted creatives may also be identified in the remaining second ad campaign #2. The identification of one or more other instances of the reviewed creatives (rejected and accepted) may occur automatically as described in detail below in regard to FIG. 6. Returning to FIG. 5, the remaining second ad campaign #2 is being automatically modified 504-3 to generate a modified ad campaign 100-2″ based on the review of the first ad campaign #1 and before a review of the second ad campaign #2. The modified ad campaign 100-2″ includes a modified schedule S2″ and a modified set of (N2-1) creatives.

The set of (N2-1) creatives that are part of the modified ad campaign 100-2″ excludes the rejected creative 108-1. Additionally, if all N1 creatives originally in ad campaign #1 are also originally contained in ad campaign #2, then the modified ad campaign 100-2″ may contain (N2-N1) or more creatives for review (not yet reviewed). The remaining (N1-1) or fewer creatives have been accepted as part of the review of ad campaign #1. Thus, the modified ad campaign 100-2″ may also include (N1-1) or fewer (flagged as) accepted creatives.

The modified schedule S2″ may be generated as described above in regard to generating the revised schedule S2″.

Furthermore, in the same state 500(b), the modified ad campaign 100-2″ is being received 506 by the reviewer unit 80 for review based on the rules discussed above regarding creative-level rejection. The received modified ad campaign 100-1″ does not include the rejected creative 108-1, as discussed above in regard to modifying 504-3 the second ad campaign #2. Instead, the received modified ad campaign 100-1″ may include [I] (N1-1) or fewer creatives that are (flagged as) accepted, and [II] (N2-N1) or more creatives for review (not yet reviewed), for a total of (N2-1) creatives. Therefore, when reviewing remaining ad campaigns, the reviewer module 80 can skip previously reviewed creative(s). Therefore, the reviewer module 80 can skip previously rejected creative(s) and previously accepted creative(s). Accordingly, the process described in FIG. 5 enables the hub 10 to save computing resources by not having to repeatedly review previously reviewed creatives.

FIG. 6 illustrates that a creative and media represent two different database entities. For example, the relational database 70, hosted by the hub 10, stores ad campaigns 100-1, 100-2, . . . Each ad campaign includes a set of creatives 108-1, 108-2, . . . As discussed earlier, each creative includes campaign-specific data and a corresponding piece of media. The relational database 70 also includes at least a table 76 that contains media 120-1, 120-2, . . . A piece of media 120-2 may be associated to Creative “2”, while Creative “2” may be contained (and scheduled) in ad Campaign “1” 100-1, ad Campaign “2”, ad Campaign “3”, etc.

The rules about ad review introduced earlier, such as the rules describing creative-level rejections, may be based on media rejection. For example, if a piece of media is rejected, a note (also referred to as a flag) is recorded in the database corresponding to the rejected media. In FIG. 3, the flag 122-2 which corresponds to rejected media 120-2 may simply say “REJ”. In other implementations, the note 122-2 may include entries indicating that the rejected media 120-2 cannot be presented in X, Y, Z places (markets) or by X, Y, Z stations. Alternatively, if a piece of media is accepted, a note (flag) is recorded in the database corresponding to the accepted media. In FIG. 3, the flag 124-1 which corresponds to accepted media 120-1 may simply say “ACC”. In other implementations, the note 124-1 may include entries indicating that the accepted media 120-1 can be presented in X, Y, Z places (markets) or by X, Y, Z stations.

In other implementations, an ad campaign 100-1″ may contain a rejected creative (Creative “2”). In that case, the rejection corresponding to the rejected Creative “2” also corresponds to its media 120-2. Thus, the rejection transfers from the rejected Creative “2” to the corresponding media 120-2. Additionally, the ad campaign 100-1″ may contain accepted creatives (Creative “1”, Creative “3”, . . . ). In that case, the acceptance of Creative “1” also corresponds to its media 120-1. Thus, the acceptance of Creative “1” transfers to its corresponding media 120-1. And so on.

The implementation illustrated in FIG. 6 corresponds to state 500(b) in FIG. 5, i.e., ad Campaign “1” 100-1 may correspond to a reviewed ad campaign. The reviewer unit 80 may have rejected Creative “2”, for example because the corresponding media 120-2 may be found to be objectionable. As described above, the rejection of Creative “2” may be automatically applied to its media 120-2, thus media 120-2 can be flagged as rejected, for example using the flag “REJ” 122-2. Additionally, the reviewer unit 80 may have accepted Creative “1”, Creative “3”, . . . As described above, the acceptance of Creative “1” may be automatically applied to its media 120-1, and thus media 120-1 can be flagged as accepted, for example using the flag “ACC” 124-1.

The outcome of the review process can be the revised ad campaign 100-1″ including the set of accepted creatives (Creative “1”, Creative “3”, . . . , excluding Creative “2”) and a revised schedule S1″. For example, the reviewer unit 80 may revise the schedule S1″ to fill the spot of rejected Creative “2” with a default creative or may leave the spot of rejected Creative “2” unfilled.

In some implementations, the name of the rejected Creative “2” and the name of the accepted Creative “1” and Creative “3” are identified in the remaining ad campaigns 100-2′ and 100-3′. Further, the flag 122-2 carried by the rejected media 120-2, and the flags 124-1, . . . , carried by the accepted media are applied to the remaining ad campaigns 100-2″ and 100-3″. In either case, the rejection of Creative “2” and the acceptance of Creative “1” and Creative “3”, . . . propagate automatically from a previously reviewed ad campaign to ad campaigns to be reviewed subsequently.

Thus, ad campaign 100-2 may initially contain only Creative “2”, scheduled at various times and/or stations. As the rejection of Creative “2” propagates to all remaining ad campaigns, the modified ad Campaign “2” 100-2″ may be rejected de facto because the modified ad Campaign “2” 100-2″ contains only rejected creatives. Additionally, ad campaign 100-3 may initially contain Creative “2”, scheduled during the first presentation slot, followed by Creatives “3”, “4”, . . . As the rejection of Creative “2” and the acceptance of Creative “3” propagates to all remaining ad campaigns, the modified ad Campaign “3” 100-3″ may contain the set of remaining creatives (excluding Creative “2”, but including accepted Creative “3”) and a revised schedule S3″. When reviewing modified ad campaign 100-3″, the reviewer unit 80 may only need review Creative 4 and other not-yet-reviewed creatives. Thus, the reviewer unit 80 may skip the previously reviewed (accepted or rejected) creatives.

As described above, the review of subsequent ad campaigns can be greatly simplified based on previously reviewed ad campaigns. One can appreciate that the efficiency (speed and reduction of computing resources) of the review process may continue to improve as more reviewed (rejected and accepted) creatives are being identified. Specifically, the identified rejected creatives can be eliminated from the remaining ad campaigns, and the identified accepted creatives can be omitted from subsequent reviews of remaining ad campaigns. Thus the ad campaigns remaining for review may become sparser and sparser as the number of previously reviewed ad campaigns increases. Therefore, the techniques described above may reduce manual effort and may decrease the time to get a previously approved creative on air.

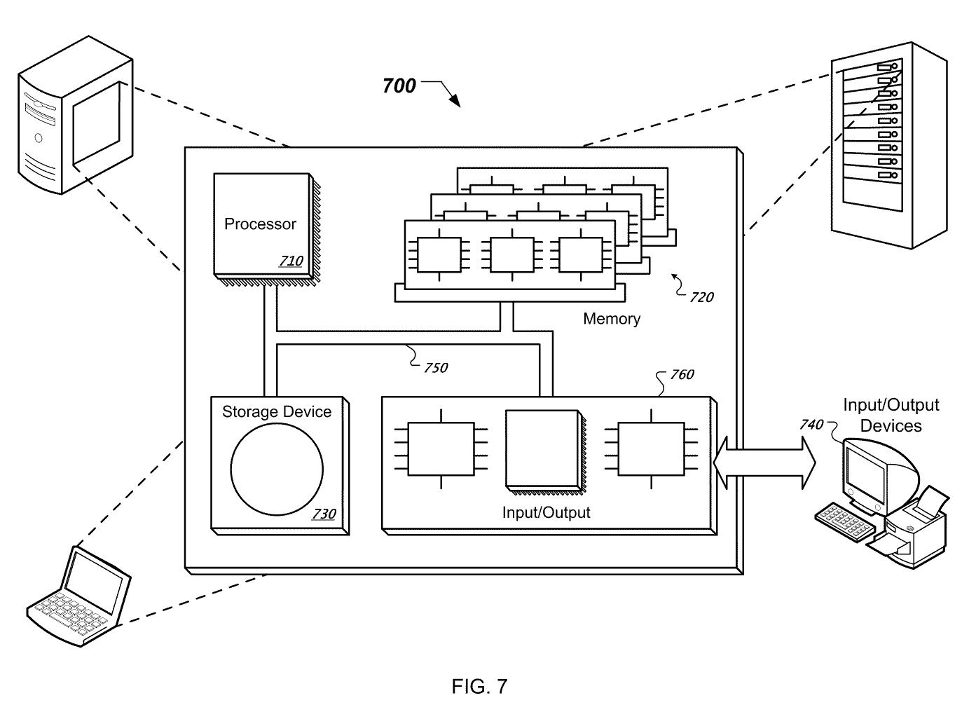

FIG. 7 is a schematic diagram of a computer system 700 representing any computerized electronic device included in the hub 10, the advertiser 20, the third party publisher 30, and the consumer 40. The system 700 can be used for the operations described in association with any of the computer-implemented methods described previously, according to the implementations described in the specification.

The system 700 is intended to include various forms of digital computers, such as laptops, desktops, workstations, personal digital assistants, servers, blade servers, mainframes, and other appropriate computers. The system 700 can also include mobile devices, such as personal digital assistants, cellular telephones, smartphones, and other similar computing devices. Additionally the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 700 includes a processor 710, a memory 720, a storage device 730, and an input/output device 740. Each of the components 710, 720, 730, and 740 are interconnected using a system bus 750. The processor 710 is capable of processing instructions for execution within the system 700. In some implementations, the processor 710 is a single-threaded processor. In other implementations, the processor 710 is a multi-threaded processor. The processor 710 is capable of processing instructions stored in the memory 720 or on the storage device 730 to display graphical information for a user interface on the input/output device 740.

The memory 720 stores information within the system 700. In some implementations, the memory 720 is a computer-readable medium. In some implementations, the memory 720 is a volatile memory unit. In other implementations, the memory 720 is a non-volatile memory unit.

The storage device 730 is capable of providing mass storage for the system 700. In some implementations, the storage device 730 is a computer-readable medium. In various different implementations, the storage device 730 may be a floppy disk device, a hard disk device, an optical disk device, or a tape device.

The input/output device 740 provides input/output operations for the system 700. In some implementations, the input/output device 740 includes a keyboard and/or pointing device. In other implementations, the input/output device 740 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier, e.g., in a machine-readable storage device or in a propagated signal, for execution by a programmable processor; and method steps can be performed by a programmable processor executing a program of instructions to perform functions of the described implementations by operating on input data and generating output.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of nonvolatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or a web server, or that includes a front-end component, such as a client computer having a graphical user interface or an Internet browser, or any combination of them. The components of the system can be connected by any form or medium of digital data communication such as a communication network. Examples of communication networks include a local area network (“LAN”), a wide area network (“WAN”), peer-to-peer networks (having ad-hoc or static members), grid computing infrastructures, and the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations of a method for verifying presentation of advertisements have been disclosed. Nevertheless, it will be understood that various modifications may be made without departing from the spirit and scope of the subject matter of this specification. For example, verifications of ads delivered over broadcast radio is presented below.

This specification describes a system and a process to allow a publisher to decline advertising creatives. The system has an interface the publisher can interact with. The publisher may control a radio station that broadcasts over the internet or over the air. The publisher may decline creatives based on advertiser, ad campaign, creative, or by media.

The methods described in this specification apply outside of internet radio and over-the-air radio. For example, TV ads are rejected as part of a publisher 30 review at ad campaign level, but it is very advantageous to review ads at media level. The methods described in this specification are applicable to any situation/system where the publisher (broadcaster) 30 reviews the media. For example, every ad campaign stored at the hub 10 has media associated to creatives included in the ad campaign. The media can be a text string to be displayed on a website, a small video clip intended for presentation on online-video sites, a high resolution high definition quality commercial intended for presentation on a broadcast TV platform, a piece of audio for radio broadcast, a piece of audio for online broadcast. All foregoing ad categories have media associated with the ad. The methods and systems disclosed in this specification enable a publisher to reject ads at media level.

Accordingly, other embodiments are within the scope of the following claims.

What is claimed is:

1. A computer-implemented method performed at a hub system, the method comprising:
receiving, from an advertiser, a plurality of ad campaigns each comprising a set of creatives and a schedule;
reviewing an ad campaign from the plurality of ad campaigns to identify an objectionable creative;
identifying one or more instances of the objectionable creative in other ad campaigns from the plurality of ad campaigns based on said reviewing the ad campaign and before reviewing the other ad campaigns; and
for each of the other ad campaigns having at least an instance from among the identified one or more instances of the objectionable creative, automatically generating a modified schedule and a modified set of creatives comprising the set of creatives minus the objectionable creative.

2. The method of claim 1, further comprising:
reviewing the other ad campaigns from the plurality of ad campaigns but skipping the objectionable creative.

3. The method of claim 2, wherein reviewing the ad campaign comprises:
examining a creative comprising media and ad campaign specific information; and
identifying the examined creative as objectionable based on the media being objectionable relative to policy mandated by at least one of the hub system, a publisher, or a government entity.

4. The method of claim 3, wherein identifying the examined creative objectionable comprises:
flagging the media comprising a media file and media specific information.

5. The method of claim 4, further comprising:
providing, to the advertiser, a summary comprising unique identifiers of the flagged media.

6. The method of claim 3, further comprising rejecting the objectionable creative.

7. The method of claim 3, further comprising:
instructing the publisher to present the reviewed ad campaigns according to respective modified schedules; and
providing, to the advertiser, a report comprising identifiers of the creatives identified objectionable.

8. The method of claim 2, wherein reviewing the ad campaign further comprises:
removing the objectionable creative from the set of creatives, wherein removing comprises one of:
extracting the objectionable creative from the set of creatives, or
flagging the objectionable creative to disallow presentation of the flagged creative by a publisher; and
revising the schedule of the ad campaign to account for spots vacated by the removed creative.

9. The method of claim 8, wherein reviewing the ad campaign further comprises:
examining a default creative selected by the advertiser;
if the examined default creative is not objectionable, revising the schedule of the ad campaign by filling the spots vacated by the removed creatives with the default creative;
if the examined default creative is objectionable, then
either identifying the ad campaign as objectionable, or
revising the schedule of the ad campaign to retain the spots vacated by the removed creatives.

10. The method of claim 8, wherein revising the schedule of the ad campaign comprises:
redistributing the set of creatives minus the removed creative to preserve a relative proportion of time, among creatives of the revised schedule, corresponding to the schedule.

11. The method of claim 1, further comprising:
identifying instances of creatives of the reviewed ad campaign in the other ad campaigns from the plurality of ad campaigns before reviewing the other ad campaigns; and
reviewing the other ad campaigns from the plurality of ad campaigns but skipping the creatives of the reviewed ad campaign.

12. An internet-based server system for reviewing a plurality of ad campaigns, the internet-based server system comprising:
a computerized electronic device communicatively coupled to:
a first computer system at a publisher; and
a second computer system at an advertiser;
the computerized electronic device configured to:
receive, from an advertiser, a plurality of ad campaigns each comprising a set of creatives and a schedule;
review an ad campaign from the plurality of ad campaigns to identify an objectionable creative;
identify one or more instances of the objectionable creative in other ad campaigns from the plurality of ad campaigns based on the review of the ad campaign and before reviewing the other ad campaigns;
for each of the other ad campaigns having at least an instance from among the identified one or more instances of the objectionable creative, automatically generate a modified schedule and a modified set of creatives comprising the set of creatives minus the objectionable creative; and
review the other ad campaigns from the plurality of ad campaigns but skipping the objectionable creative.

13. The internet-based server system of claim 12, the computerized electronic device configured to:
examine a creative comprising media and ad campaign specific information; and
identify the examined creative as objectionable based on the media being objectionable relative to policy mandated by at least one of the internet-based server system, a publisher, or a government entity.

14. The internet-based server system of claim 13, the computerized electronic device configured to:
flag the media comprising a media file and media specific information; and
provide, to the advertiser, a summary comprising unique identifiers of the flagged media.

15. The internet-based server system of claim 13, the computerized electronic device configured to reject the objectionable creative.

16. The internet-based server system of claim 12, the computerized electronic device configured to:
remove the objectionable creative from the set of creatives; and
revise the schedule of the ad campaign to account for spots vacated by the removed creative.

17. The internet-based server system of claim 16, the computerized electronic device configured to:
examine a default creative selected by the advertiser;
if the examined default creative is not objectionable, revise the schedule of the ad campaign by filling the spots vacated by the removed creatives with the default creative;
if the examined default creative is objectionable, then
either identify the ad campaign as objectionable, or
revise the schedule of the ad campaign to retain the spots vacated by the removed creatives.

18. The internet-based server system of claim 16, the computerized electronic device configured to:
redistribute the set of creatives minus the removed creative to preserve a relative proportion of time, among creatives of the revised schedule, corresponding to the schedule.

19. The internet-based server system of claim 12, the computerized electronic device configured to:
identify instances of creative of the reviewed ad campaign in the other ad campaigns from the plurality of ad campaigns before review of the other ad campaigns from the plurality of ad campaigns; and
review the other ad campaigns from the plurality of ad campaigns but skipping the creatives of the reviewed ad campaign.

20. The internet-based server system of claim 12, the computerized electronic device configured to:
instruct the publisher to present the reviewed ad campaigns according to respective modified schedules; and
provide, to the advertiser, a report comprising identifiers of the creatives identified objectionable.
